(19) United States
(12) Patent Application Publication
(10) Pub. No.: US 2006/0071440 A1
(43) Pub. Date: Apr. 6, 2006

(54) Mid drive scooter

(76) Inventors: Gerald E. Fought, Columbia Station, OH (US); John Jindra, Elyria, OH (US); Nirav Pandya, North Olmsted, OH (US); Gerald Goertzen, Brunswick, OH (US); William A. Null JR., Sullivan, OH (US)

Correspondence Address: CALFEE HALTER & GRISWOLD, LLP, 800 SUPERIOR AVENUE, SUITE 1400, CLEVELAND, OH, 44114, US

(21) Appl. No.: 10/952,695

(22) Filed: Sep. 29, 2004

(51) Int. Cl. B60G 21/05

(52) U.S. Cl. 280/124.128

(57) ABSTRACT

A mid drive scooter includes a frame that supports a seat for a rider of the scooter, a front wheel connected with the frame, left and right drive wheels, and left and right rear wheels. A left suspension is interposed between the frame and the left wheels, and a right suspension is interposed between the frame and the right wheels. The suspensions support the frame on the drive wheels for movement of the frame relative to the drive wheels in first and second degrees of freedom.

### BACKGROUND OF THE INVENTION

The present invention relates to a personal mobility vehicle. In particular, the present invention relates to a mid-drive scooter, that is, a scooter that has drive wheels located longitudinally between one or more front wheels and one or more rear wheels of the scooter.

### SUMMARY OF THE INVENTION

In one aspect the invention relates to a mid drive scooter for movement along the ground, including a frame that supports a seat for a rider of the scooter. A front wheel and left and right rear wheels are connected with the frame. Left and right drive wheels are connected with the frame between the front wheel and the rear wheels. A left suspension is interposed between the frame and the left wheels, and a right suspension is interposed between the frame and the right wheels. Each one of the left side and right suspensions includes a pivot arm connected with the frame for pivotal movement relative to the frame about a first pivot axis, the drive wheel being connected forward of the first pivot axis on a portion of the pivot arm, the rear wheel being connected rearward of the first pivot axis on a portion of the pivot arm, and the pivot arm supporting the frame on the drive wheel for movement of the frame relative to the drive wheel in first and second degrees of freedom.

### BRIEF DESCRIPTION OF THE DRAWINGS

Further features and advantages of the present invention will become apparent to those of ordinary skill in the art to which the invention pertains from a reading of the following description together with the accompanying drawings, in which:

FIG. 1 is a schematic top plan view of a scooter in accordance with a first embodiment of the invention, with portions of the scooter removed for clarity;

FIG. 2 is a schematic right side elevational view of the scooter of FIG. 1 showing the frame and suspension components of the scooter is a neutral condition;

FIG. 3 is a view similar to FIG. 2 showing the frame and suspension components in a condition in which the scooter is turning right;

FIG. 4 is a schematic left side elevational view of the scooter of FIG. 1 showing the frame and suspension components in the condition in which the scooter is turning right;

FIG. 5 is a schematic rear elevational view of the scooter of FIG. 1 showing the frame and suspension components of the scooter is a neutral condition;

FIG. 6 is a view similar to FIG. 5 showing the frame and suspension components in the condition in which the scooter is turning right;

FIG. 7 is an enlarged schematic illustration of a bushing assembly that forms part of the scooter of FIG. 1, shown in a neutral condition;

FIG. 8 is a view similar to FIG. 7 showing the bushing assembly in the condition in which the scooter is turning right; and

FIG. 9 is a schematic side elevational view of a scooter in accordance with a second embodiment of the invention.

### DETAILED DESCRIPTION

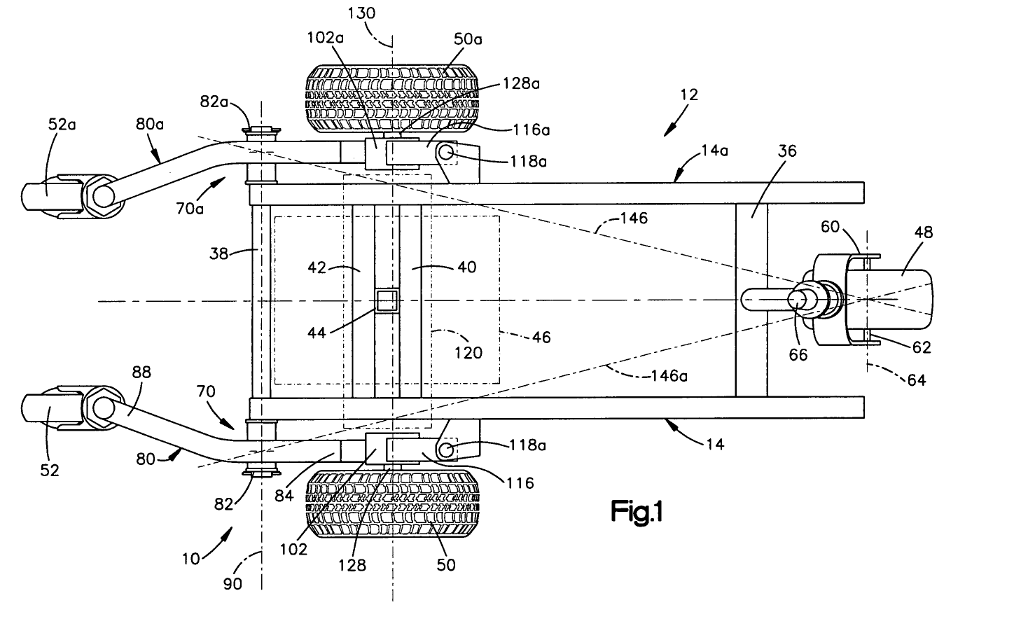

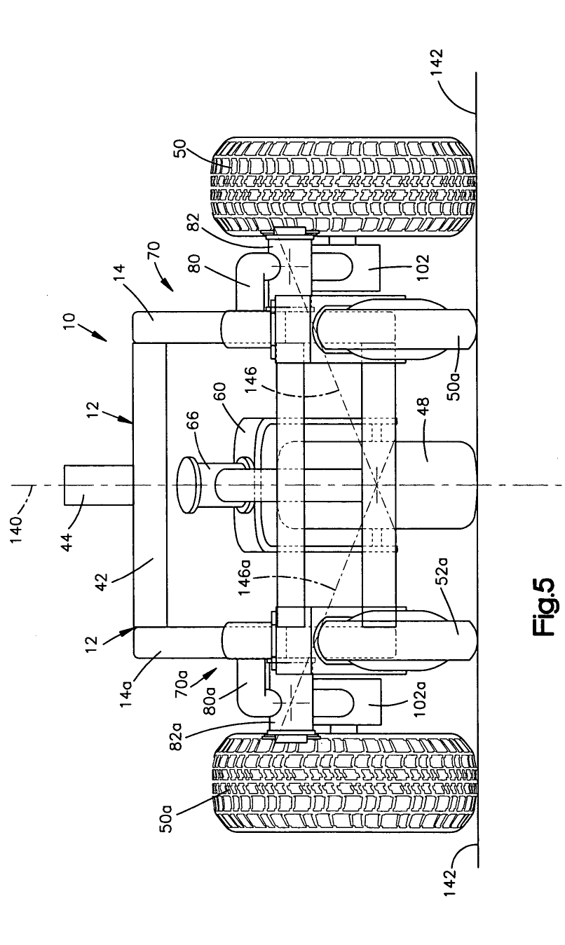

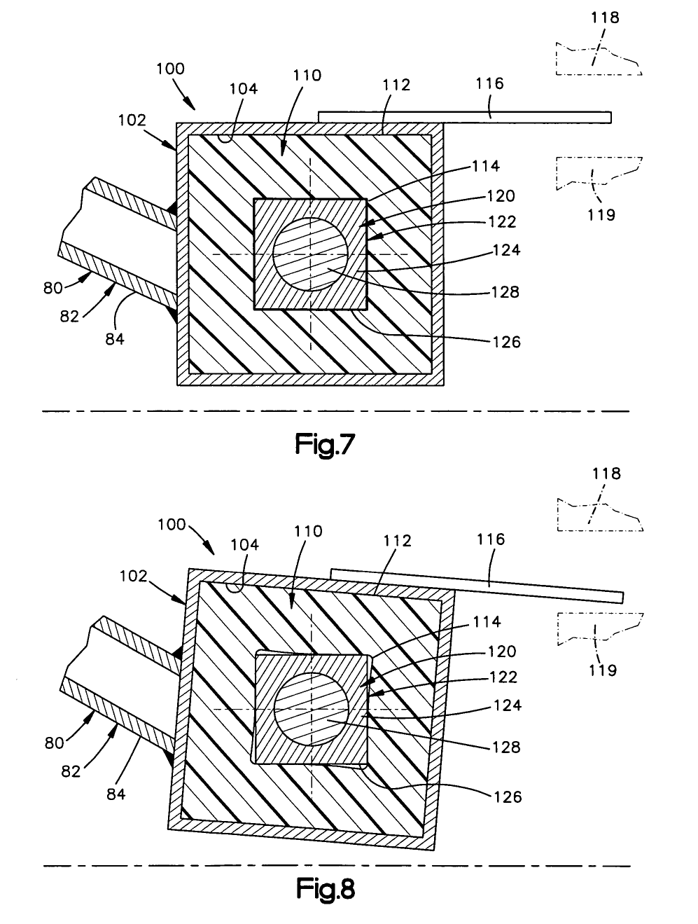

The present invention relates to a personal mobility vehicle. In particular, the present invention relates to a mid-drive scooter, that is, a scooter that has drive wheels located longitudinally between one or more front wheels and one or more rear wheels of the scooter. The invention is applicable to personal mobility vehicles and scooters of various differing constructions. As representative of the present invention, FIGS. 1-8 illustrate a scooter 10 constructed in accordance with a first embodiment of the invention.

The scooter 10 (FIGS. 1, 2 and 5) includes as its main structural component a frame 12. The frame 12 includes a right side rail 14, a left side rail 14a and a plurality of braces and cross members.

The left side rail 14a is similar in construction and configuration to the right side rail 14. Parts of the left side rail 14a that correspond to parts of the right side rail 14 are given the same reference numerals with the suffix “a” added to distinguish them.

The right side rail 14 includes a front arm 20, a transition portion 20, a middle portion 24, and a back arm 26. When the scooter 10 is at rest the front arm 20 extends generally horizontally from near the front of the scooter to approximately the mid-point of the scooter. The transition portion 22 of the right side rail 14 extends upward and rearward from a back end portion 28 of the front arm 20.

The middle portion 24 of the right side rail 14 extends rearward from the transition portion 22 in a direction generally parallel to the front arm 20. The back arm 26 of the right side rail 14 of the frame 12 extends generally vertically downward from a back end portion 30 of the middle portion 24 of the right side rail 14. The back arm 26 has a lower end portion 32.

The right and left side rails 14 and 14a of the frame 12 are joined by four cross members. A front cross member 36 extends generally perpendicular to and between the front arms 20 and 26a of the right and left side rails 14 and 14a, respectively. A rear cross member 38 extends generally perpendicular to and between the back arms 26 and 26a of the right and left side rails 14 and 14a, respectively. First and second center cross braces 40 and 42 extend generally perpendicular to and between the middle portions 24 and 24a of the right and left side rails 14 and 14a, respectively.

A seat post 44 is situated between the forward and rearward center cross braces 40 and 42. The seat post 44 is attached to and extends vertically upward from the braces 40 and 42. The seat post 44 is designed to accept a seat, shown schematically at 46, that can be removably attached to the seat post. The seat 46 transfers the weight of the operator to the frame 12, which transfers that weight to one front wheel 48, two drive wheels 50 and 50a, and two rear wheels 52 and 52a of the scooter.

The front wheel 48 is attached to a front wheel fork 60 by a front wheel axle 62. The axle 62 supports the front wheel 48 for rotation about a front wheel axis 64 of the scooter 10. The fork 60 is connected with a steerable tiller 66. A front wheel brace 68 extends between the tiller 66 and the front cross member 36. The tiller 66, which is rigidly attached to the fork 60, translates steering movement from the operator through the fork to the front wheel 48. The operator can guide the scooter into right or left turns by tuning the tiller 66 in the desired direction.

The scooter 10 includes a suspension that supports the drive wheels 50 and 50a and the rear wheels 52 and 52a on the frame 12 for movement relative to the frame. On the right side of the scooter 10, the suspension 70 includes a right pivot arm 80. The right pivot arm 80 is pivotally coupled to the frame 12 through a pivot connection 82 on the lower end portion 32 of the back arm 26 of the right side rail 14. (A “connection” as used herein can be a direct connection, that is, piece to piece, or can be an indirect connection, that is, with one or more pieces in between.)

The pivot arm 80 has a front portion 84 that is located forward of the pivot connection 82. The front portion 82 of the pivot arm 80 includes a leading end portion 84 of the pivot arm. The pivot arm 80 also has a back portion 86, located rearward of the pivot connection 82. The back portion 86 of the pivot arm 80 includes a trailing end portion 88 of the pivot arm.

The pivot connection 82 defines a first pivot axis 90 that extends through the rear cross member 38 in a transverse direction across the scooter 10. The pivot arm 80 is supported on the right side rail 14 of the frame 12 for pivotal movement relative to the frame about the first pivot axis 90.

A right rear wheel assembly 90 of the scooter 10 is coupled to the trailing end portion 88 of the right pivot arm 80. The right rear wheel assembly 92 includes the right rear wheel 52 which, in the illustrated embodiment, is a caster. The assembly 92 also includes a fork 94 that supports the right rear wheel 52 for rotation about a rear wheel axis 96. The fork 94 is, itself, preferably rotatable about a generally vertical axis, relative to the pivot arm 80.

A right bushing assembly 100 (FIG. 10), which forms part of the suspension 70, extends from the leading end portion of the pivot arm 80. The right bushing assembly 100 includes a right bushing housing 102. The right bushing housing 102 is rigidly attached to the leading end portion 84 of the right pivot arm 80. The right bushing housing 102 in the illustrated embodiment has a square, box-shaped configuration including an inner side surface 104.

The right bushing assembly 100 also includes a right bushing 110. The right bushing 110 is made from an elastomeric material, for example, rubber. The right bushing 110 is configured to fit closely within the right bushing housing 102 and thus, in the illustrated embodiment, has a square configuration with an outer side surface 112. The outer side surface 112 of the right bushing 110 is in abutting engagement with the inner side surface 104 of the right bushing housing 102. The right bushing 110 also has a central opening 114.

A flange 116 extends forward from the right bushing housing 102 to a location between two mechanical stops 118 and 119 on the right side rail 14 of the frame. The engagement of the flange 116 with the stops 118 and 119 can limit or control the range of movement of the bushing housing 102, as described below.

The suspension 70a (FIG. 1) on the left side of the scooter 10 is similar to the right side suspension 70 as described above, and its components are given the same reference numerals with the suffix “a” added to distinguish them. For example, the left pivot arm 80 and its coupling to the frame 12 is similar to the right pivot arm 80 and its coupling to the frame. The first pivot axis 90 extends through the pivot connection 82a between the left pivot arm 80a and the frame 12. The left pivot arm 80a is pivotable about the first pivot axis 90 relative to the frame 12, independently of the right pivot arm 80. The left side suspension 70a also includes a left bushing assembly 100a that is a mirror image of the right bushing assembly 100.

The scooter 10 includes a transaxle 120 that extends between and interconnects the right drive wheel 50 and the left drive wheel 50a. The transaxle 120 includes a housing 122. A right end portion 124 of the transaxle housing 122 extends through the central opening 114 of the right bushing 110. In the illustrated embodiment the transaxle housing 122 and the opening 114 in the bushing 110 are square. The transaxle housing right end portion 124 has an outer side surface 126 which extends through the central opening 114 in the right bushing 110 and which is in abutting engagement with the bushing 110. A right drive axle 128 extends from the right end portion 124 of the transaxle housing 122 and is fixed for rotation with the right drive wheel 50.

A left end portion 124a (not shown) of the transaxle housing extends through the left bushing 110a. A left drive axle 128a extends from the left end portion 124a of the transaxle housing 120 and is fixed for rotation with the left drive wheel 50a.

The transaxle 120 and the drive wheels 50 and 50a define a drive axis 130 of the scooter 10. The drive axis 130 is located between the front wheel axis 64 and the first pivot axis 90. The drive axis 130 extends laterally across the scooter 10. The drive axis 130 is preferably located below or nearly below the seat post 44 of the scooter 10, so that the weight of the operator is located substantially over the drive wheels 50 and 50a of the scooter 10.

Because the drive wheels 50 and 50a are attached to the pivot arms 80 and 80a through the bushing assemblies 10 and 110a, the pivot arms are movable relative to the drive wheels in two degrees of freedom. A degree of freedom may be defined as any one of the number of ways in which the space configuration of a mechanical system may change; or as any one of a limited number of ways in which a point or a body may move or in which a dynamic system may change.

The first degree of freedom is about the drive axis 130 and is pivotal motion of the pivot arms 80 and 80a about the drive axis 130. (If a bushing 110 or 110a is deformed rather than in its neutral state, its associated pivot arm 80 or 80a might pivot about an axis that is slightly off a little from the drive axis 130; a statement herein that the pivot arm pivots about the drive axis is intended to include such circumstances.)

This pivotal movement of the pivot arm 80 is enabled by the rubber bushing 110. Specifically, as the pivot arm 80 pivots about the drive axis 130, the bushing housing 102 also rotates about the drive axis. The rotation of the bushing housing 102 deforms the bushing 110, which is captured between the bushing housing and the transaxle housing 122. The elastomeric material of the bushing 110 resists deformation, and so the deformation stores energy in the bushing. Once the force causing the pivot arm 80 to pivot is released, the energy stored in the bushing 110 helps to restore the pivot arm to its original position, with respect to the drive wheel 50.

This first degree of freedom of the pivot arm 80 relative to the drive wheel 50 provides a first degree of freedom of the frame 12 relative to the drive wheel. As the pivot arm 80 pivots about the drive axis 130, the frame 12 moves relative to the drive wheel also, because of the connection between the pivot arm and the frame.

The second degree of freedom of the pivot arm 80 relative to the drive wheel 50 is exemplified in horizontal twisting movement of the bushing housing 102 relative to the transaxle housing 122. There may be some play between the bushing 110 and the bushing housing 102. In addition, the bushing 110 is deformable. As a result, the bushing housing 102 and thus the entire pivot arm can twist, or tilt, relative to the transaxle housing 122, about an axis that, for example, runs generally fore and aft in the scooter 10.

This second degree of freedom of the pivot arm 80 relative to the drive wheel 50 provides a second degree of freedom of the frame 12 relative to the drive wheel. As the pivot arm 80 twists or tilts relative to the transaxle 120 and the drive wheel 50, the frame 12 twists or tilts relative to the transaxle and the drive wheels also, because of the connection between the pivot arm and the frame.

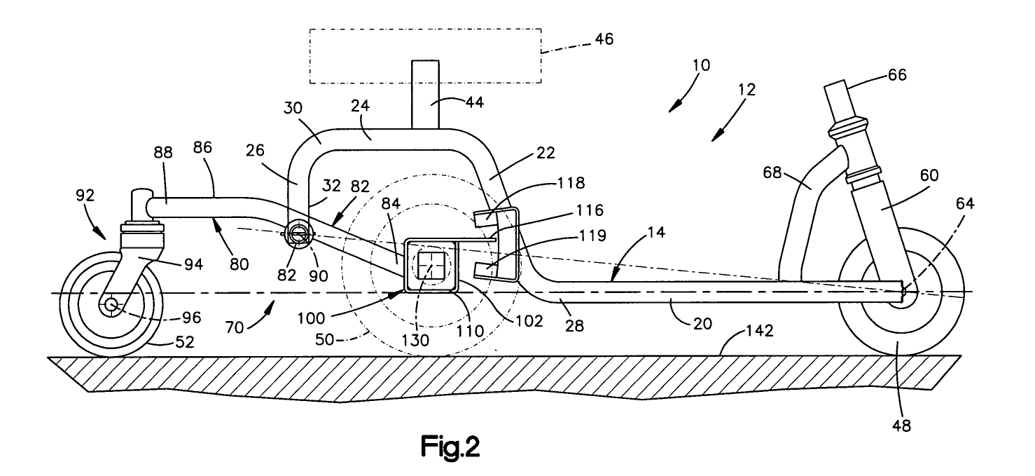

When the scooter 10 is at rest or is moving forward along a straight line on a smooth surface, the positions of portions of the frame 12 and suspension components that are on the left side of the scooter are generally a mirror image of the positions of the comparable frame and suspension components on the right side of the scooter. In this state, the frame 12 and suspension components are in the neutral position or neutral condition shown in FIGS. 2 and 8. The left side components and comparable right side components are generally equidistant from the vertical plane 140 (FIG. 8) that includes the centerline of the scooter. In addition, the left side components and the comparable right side components are generally the same distance from a horizontal plane defined by the supporting surface (the ground or ground surface 142).

All five wheels 48-52a of the scooter 10 are in contact with the ground 142. The left drive wheel 50a supports substantially the same weight as the right drive wheel 50. The left rear wheel 52a supports substantially the same weight as the right rear wheel 52. The front wheel 48 supports the remainder of the weight of the scooter 10 and the operator. The left and right bushings 110 and 110a are in a neutral state in their respective bushing housings 102 and 102a.

The cross members 36-42 joining the right and left side of the frame 12 are generally parallel to the horizontal supporting surface 142. The right and left front arms 20 and 20a of the frame 12 are generally parallel to the horizontal supporting surface 142. On each side of the scooter 10, the flange 116 extending from the bushing housing 102 is positioned between the upper mechanical stop 118 and the lower mechanical stop 119, without being in contact with either.

When the scooter 10 is in motion, the frame 12 and the suspension 70, 70a of the scooter can experience relative movement. This is particularly the case when the scooter 10 is making a left hand turn or a right hand turn. In such a case, the frame 12 and suspension 70, 70a of the scooter 10 cooperate to help promote stability of the scooter.

Specifically, when the scooter 10 turns, the frame 12 has a tendency to tilt, because of centrifugal force, with respect to the ground 142 and to the vertical plane 140 through the scooter centerline. The frame 12 supports the seat 46 and the operator of the scooter. The suspension 70, 70a enables this tilting movement while minimizing the possibility of tipping over of the scooter 10, as described below. In addition, the configuration and operation of the frame 70 and the suspension 70, 70a help to maintain both drive wheels 50 and 50a in contact with the supporting surface 142 during a turn, as described below.

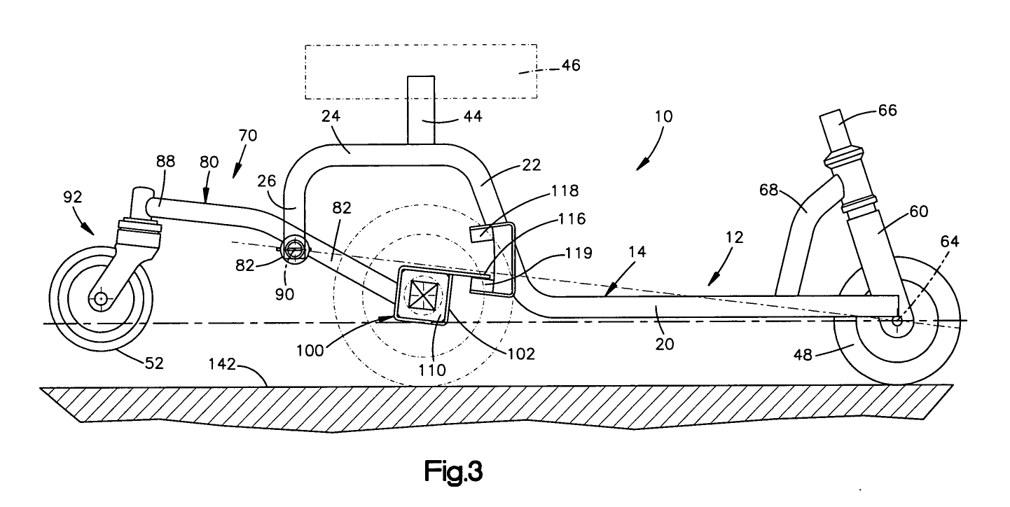

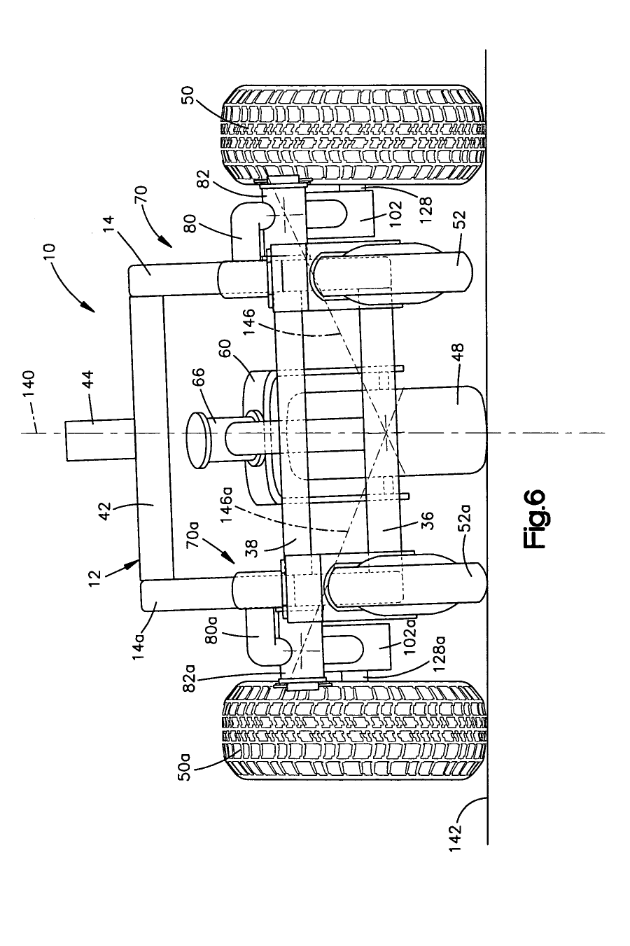

In a right hand turn, for example, the tendency is for the operator and the seat 46 and the frame 12 to tilt toward the outside of the turn, that is, to the left, because of centrifugal force. During such a turn the frame 12 and the suspension components can move through a number of different positions. FIGS. 3 and 6 illustrate one representative position of the frame and the suspension components during a right hand turn. FIG. 3 is a right side elevational view that shows the frame and suspension components of the scooter 10 in a condition in which the scooter is turning right. FIG. 6 is a schematic rear elevational view of the scooter 10 showing the frame and suspension components of the scooter in the condition in which the scooter is turning right;

During a right hand turn, the frame 12 tilts about a right turn pivot axis shown at 146 in FIGS. 1 and 6. The right turn pivot axis 146 extends between the center of the front wheel 48 and the left pivot arm connection 82a.

The degree of movement of the frame 12 and suspension components during a turn may be determined by the speed of the scooter through the turn, and the radius of the turn. The greater the speed, the greater the relative motion of frame and suspension components. The smaller the radius of the turn, the greater the relative motion of frame and suspension components

As the frame 12 tilts left, relative to the fixed vertical plane 140, the pivot arm 80 tilts with the frame, because the pivot arm has only one degree of freedom of movement relative to the frame. When the frame 12, and thus the pivot arm 80, tilt, the bushing housing 102 also tilts. During this movement the bushing 110 can slide horizontally within the bushing housing 102 to accommodate the tilting of the bushing housing.

As the frame 12 tilts or rotates about the right turn pivot axis 146, the portion of the frame that experiences the most upward movement is the rearmost right portion, which is the right back arm 26 of the frame. The portion of the frame 12 that experiences the most downward movement is the forward most left portion, which is the left front arm 20a of the frame.

During this tilting movement, the portions of the frame 12 that are to the left of the right turn pivot axis 146 move in a generally downward direction, that is, toward the ground.

The portions of the frame 12 that are to the right of the right turn pivot axis 146 move in a generally upward direction, that is, away from the ground 142. For instance, the right side rail 14 is one of these frame portions; therefore, the right side rail moves upward, away from the ground 142. Because the right pivot connection 82 is located to the right side of the right turn pivot axis 146, and is on the right side rail 14, a right hand turn causes the right pivot connection 82 to be pulled upward, away from the ground 142, as the right side rail moves upward. As a result, upwardly directed force is applied to the right pivot connection 82. This force acts through the pivot connection 82 and is transmitted into the right pivot arm 80, including both the forward portion 82 of the right pivot arm and the back portion 86 of the right pivot arm.

The configuration of the suspension 70 is such that the upwardly directed force that is transmitted into the right pivot arm 80 tends to lift the right rear wheel 52, and not the right drive wheel 50, off the ground. Specifically, the right rear wheel 52, the right drive wheel 50, and the right pivot connection 82, as joined by the right pivot arm 80, form a rigid triangular structure. The right rear wheel 52 is at one corner (the back corner) of this imaginary triangle. The right drive axis 130 is at another corner (the front corner) of this imaginary triangle. The right pivot connection 82 is at the top corner of this imaginary triangle. Because of this rigid triangular relationship and the single-axis nature of the pivot connection 82, at least one of the wheels 50 and 52 must move upward when the right pivot connection 82 moves upward.

The downward slant of the front portion 82 of the right pivot arm 80, as well as the front to back placement of the right pivot connection 82 along the length of the right pivot arm 80, causes the right drive wheel 50 to be more heavily loaded than the right rear wheel 52. As a result, the resistance to lifting of the right drive wheel 50 is greater than that of the right rear wheel 52, and so it is the right rear wheel that moves (is lifted) upward when the scooter frame 12 tilts to the left in a right hand turn. The right drive wheel 50 remains in contact with the ground surface 142.

When the right rear wheel 52 lifts upward and the right drive wheel 50 stays on the ground, the right pivot arm 80 as a result rotates about the right pivot connection 82. The right pivot arm 80 rotates in a clockwise direction as viewed in FIG. 3.

Simultaneously, the pivot arm 80 pivots about the drive axis 130, and all portions of the right pivot arm 80 that are rearward of the drive axis move upward relative to the ground surface 142 on which the right drive wheel 50 is located. The vertical displacement of each portion of the right pivot arm 80 is dependent on its location along the pivot arm; the closer to the drive axis 130, the lesser is the upward displacement, and the farther from the pivot axis, the greater is the upward displacement.

Further, the pivoting of the right pivot arm 80 relative to the drive axis 130 and the transaxle 120 causes the right bushing housing 102 to rotate about the drive axis. The right bushing 110 is deformed when the right bushing housing 102 rotates about the transaxle housing 122. In addition, as the frame 12 tilts, the right bushing 110 may also experience some lateral compressive forces, with respect to the right bushing housing, either towards or away from the vertical plane 144 extending through the centerline of the scooter.

The rotation of the right bushing housing 102 also causes the flange 116 on the right bushing housing to move downward between the two mechanical stops 118 and 119, in a direction toward the supporting surface 142 and the right lower mechanical stop 119. At the same time, because of the tilting of the frame 12, the right lower mechanical stop 119, which is rigidly attached to the frame, moves away from the supporting surface 142 and towards the right flange 116. If the frame 12 tilts sufficiently in a right hand turn, the flange 116 engages the stop 118, to limit the rotation of the right pivot arm 80 in the clockwise direction as viewed in FIG. 3.

While the right pivot arm 80 is pivoting upward and also rotating relative to the frame 12, the left drive wheel 50 and the left rear wheel 52 stay on the ground. The right turn pivot axis 146 extends through the left pivot connection 82a, and as a result, the left pivot connection does not experience significant any vertical movement. The left drive wheel 50a is to the left of the right turn pivot axis 146, and so it experiences downward force rather than upward force.

The left rear wheel 52a and the left pivot arm 80 may experience a small amount of upward force, but not enough to pivot the left pivot arm significantly or to lift the left rear wheel off the ground. There is no significant rotation of the left bushing housing 102a relative to the drive axis 130. The left bushing 110a may experience some lateral movement, with respect to the left bushing housing 102a, by either moving towards or away from the vertical plane 140 extending through the centerline of the scooter.

As the scooter 10 completes the right turn and either comes to a stop or continues along a straight line, the movements described above reverse, and the scooter frame 12 and the suspension components return to the positions and orientations they occupied before the initiation of the turn.

The relative movement of the frame 10 and suspension components 70, 70a as the scooter traverses a left hand turn, are mirror images of the movements that occur when the scooter traverses a right hand turn. The part movements occur with respect to a left turn pivot axis 146a that extends generally between the front wheel 48 and the right pivot connection 82.

The parts of the scooter frame that are to the left of the left turn pivot axis move generally upward. Thus, in a left hand turn, the left rear wheel 52a can lift up but the left drive wheel 50a stays on the ground.

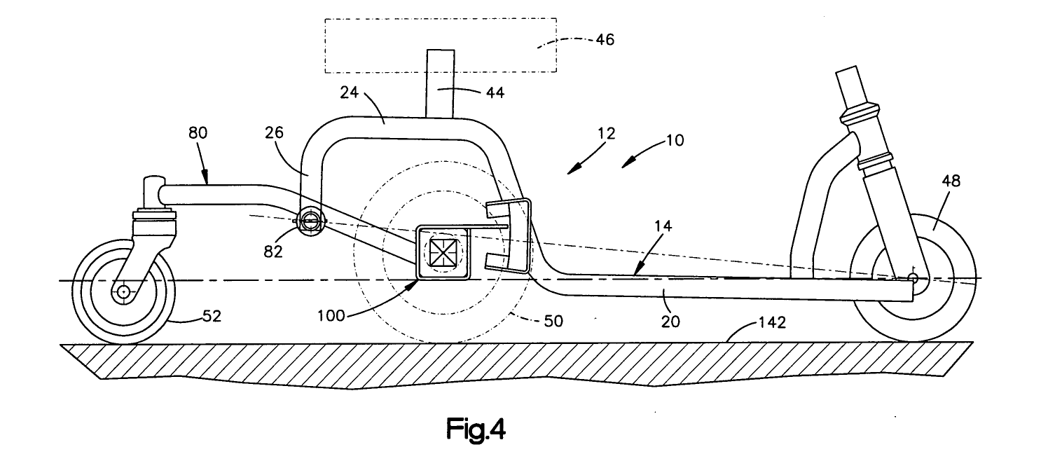

The parts of the scooter frame that are to the right of the left turn pivot axis move generally downward. This includes, for example, the right side rail 14, as illustrated in FIG. 4 which is a view from the right side of the vehicle when the vehicle is in a left turn. Also, both right side wheels 50 and 52 stay on the ground. As a result, the stability of the scooter 10 is enhanced.

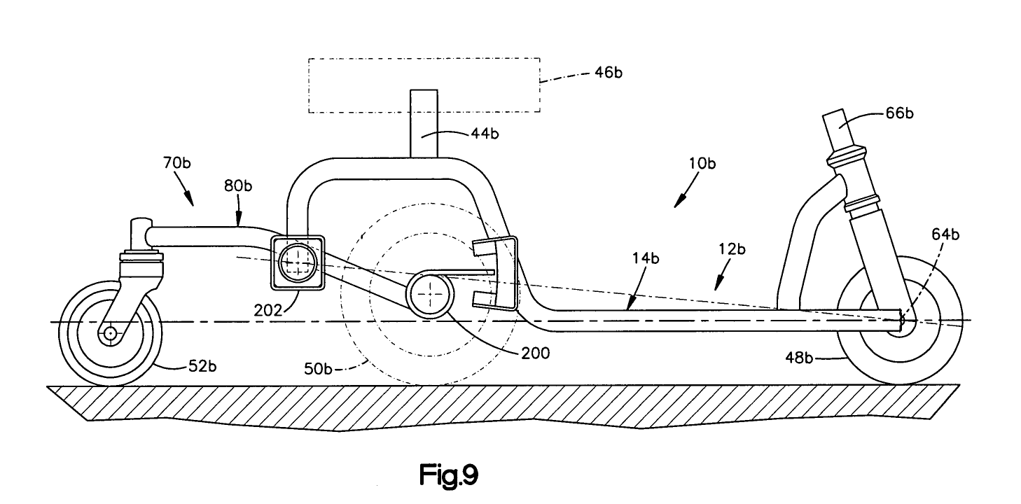

FIG. 9 illustrates schematically a portion of a suspension 70b of a scooter 10b that is a second embodiment of the invention. The scooter 10b includes right and left suspensions that are similar to each other. The parts of the right suspension 70b of the scooter 10b, illustrated in FIG. 9 are given the same reference numerals as the corresponding parts of the right suspension 70 of the scooter 10, with the suffix “b” added to distinguish.

The suspension 70b includes a pivot arm 80b that supports a frame 12b on a right drive wheel 50b and a right rear wheel 52b. The connection 200 between the pivot arm 80b and the drive wheel 50b is a pivot connection that allows only one degree of freedom, instead of the two degrees of freedom that are allowed by the right bushing assembly 100 shown with regard to the first embodiment of the invention. In the suspension 70b, the connection 202 between the pivot arm 80b and the frame 12b is a connection that allows two degrees of freedom, instead of the one degree of freedom that is allowed by the pivot connection 72 shown with regard to the first embodiment of the invention. Thus, the frame 12b still has two degrees of freedom with regard to the drive wheel 70b.

From the above description of the invention, those skilled in the art will perceive improvements, changes, and modifications in the invention. Such improvements, changes, and modifications within the skill of the art are intended to be included within the scope of the appended claims.

1. A mid drive scooter for movement along the ground, comprising:
a frame that supports a seat for a rider of the scooter;
a front wheel connected with the frame;
left and right rear wheels connected with the frame;
left and right drive wheels connected with the frame between the front wheel and the rear wheels;
a left suspension interposed between the frame and the left wheels; and
a right suspension interposed between the frame and the right wheels;
each one of said left side and right suspensions including a pivot arm connected with the frame for pivotal movement relative to the frame about a first pivot axis, the drive wheel being connected forward of the first pivot axis on a portion of the pivot arm, the rear wheel being connected rearward of the first pivot axis on a portion of the pivot arm, and the pivot arm supporting the frame on the drive wheel for movement of the frame relative to the drive wheel in first and second degrees of freedom.

2. A scooter as set forth in claim 1 wherein the frame is connected with the pivot arm at the first pivot axis for relative movement between the frame and the pivot arm in first and second degrees of freedom.

3. A scooter as set forth in claim 1 wherein the pivot arm is connected with the drive wheel for relative movement between the pivot arm and the drive wheel in first and second degrees of freedom.

4. A scooter as set forth in claim 3 further including a transaxle extending between the left drive wheel and the right drive wheel, the transaxle having a portion that is interposed between the pivot arm and the right drive wheel in a manner providing for relative movement between the pivot arm and the transaxle in first and second degrees of freedom.

5. A scooter as set forth in claim 4 including an elastomeric bushing that cooperates with the interposed transaxle portion to provide for relative movement between the pivot arm and the transaxle in first and second degrees of freedom.

6. A scooter as set forth in claim 5 wherein the elastomeric bushing is disposed in a bushing housing that moves with said pivot arm, the bushing having an opening through which the transaxle portion extends.

7. A scooter as set forth in claim 1 wherein the first degree of freedom of the frame relative to the drive wheel is pivotal movement about a drive axis of the vehicle that extends between the left and right drive wheels.

8. A scooter as set forth in claim 7 wherein the connection between the drive wheel and the portion of the pivot arm forward of the first pivot axis is a pivotal connection that includes an elastomeric bushing.

9. A scooter as set forth in claim 1 wherein the second degree of freedom of the frame relative to the drive wheel is tilting movement of the frame relative to the drive wheel.

10. A scooter as set forth in claim 9 wherein the tilting movement of the frame relative to the drive wheel is enabled by an elastomeric bushing adjacent the drive wheel.

11. A scooter as set forth in claim 1 wherein pivotal movement of the pivot arm relative to the frame causes the rear wheel to lift off the ground while maintaining the drive wheel on the ground.

12. A scooter as set forth in claim 1 wherein the drive wheel is supported on a forward portion of the pivot arm that slants downward from the first pivot axis.

13. A scooter as set forth in claim 1 wherein the scooter has a right turn pivot axis that extends generally between the front wheel and the pivot connection between the left pivot arm and the frame, the frame being tiltable about the right turn pivot axis in a right turn of the scooter, and a left turn pivot axis that extends generally between the front wheel and the pivot connection between the right pivot arm and the frame, the frame being tiltable about the left turn pivot axis in a left turn of the scooter.

14. A scooter for movement along the ground, comprising:
a frame that supports a seat for a rider of the scooter;
a front wheel, a left side wheel and suspension and a right side wheel and suspension that together support the frame for rolling movement along the ground;
each one of said left side wheel and suspension and said right side wheel and suspension including a drive wheel and a rear wheel;
the left and right side suspensions cooperating with the frame as the scooter goes around a turn to enable the seat and the frame to tilt toward the outside of the turn and to enable the inside rear wheel to lift off the ground while maintaining both drive wheels on the ground.

15. A scooter as set forth in claim 14 wherein the scooter has a right turn pivot axis that extends generally between the front wheel and the pivot connection between the left pivot arm and the frame, the frame being tiltable about the right turn pivot axis in a right turn of the scooter, and a left turn pivot axis that extends generally between the front wheel and the pivot connection between the right pivot arm and the frame, the frame being tiltable about the left turn pivot axis in a left turn of the scooter.

16. A scooter as set forth in claim 15 wherein each one of the left and right side suspensions includes a pivot arm that supports the frame on the drive wheel for movement of the frame relative to the drive wheel in first and second degrees of freedom.

17. A scooter as set forth in claim 16 wherein the first degree of freedom of the frame relative to the drive wheel is pivotal movement about a drive axis of the vehicle that extends between the left and right drive wheels.

18. A scooter as set forth in claim 17 including an elastomeric bushing connecting the drive wheel and the pivot arm.

19. A scooter as set forth in claim 16 wherein the second degree of freedom of the frame relative to the drive wheel is tilting movement of the frame relative to the drive wheel.

20. A scooter as set forth in claim 19 including an elastomeric bushing adjacent the drive wheel that at least partially enables the tilting movement of the frame relative to the drive wheel.

21. A scooter for movement along the ground, comprising:
a frame that supports a seat for a rider of the scooter;
a front wheel;
a left side wheel and suspension arrangement that includes a left drive wheel and a left rear wheel;
a right side wheel and suspension arrangement that includes a right drive wheel and a right rear wheel;
the front wheel and the left and right wheel and suspension arrangements together supporting the frame for rolling movement along the ground;
lateral force on the seat arising from movement of the scooter around a turn being transferred through the seat and the frame to the left and right side suspensions and thereby to the left and right drive wheels and rear wheels, the lateral force causing the seat and the frame to roll toward the outside of the turn and to lift the inside rear wheel while both drive wheels are maintained on the ground.

22. A scooter as set forth in claim 21 wherein each one of the left and right side suspensions includes a pivot arm that supports the frame on the associated drive wheel for movement of the frame relative to the drive wheel in first and second degrees of freedom.

23. A scooter as set forth in claim 22 wherein the first degree of freedom of the frame relative to the drive wheel is pivotal movement about a drive axis of the vehicle that extends between the left and right drive wheels.

24. A scooter as set forth in claim 23 including an elastomeric bushing connecting the drive wheel and the pivot arm.

25. A scooter as set forth in claim 22 wherein the second degree of freedom of the frame relative to the drive wheel is tilting movement of the frame relative to the drive wheel.

26. A scooter as set forth in claim 22 wherein the first degree of freedom of the frame relative to the drive wheel is pivotal movement about a drive axis of the vehicle that extends between the left and right drive wheel and the second degree of freedom of the frame relative to the drive wheel is tilting movement of the frame relative to the drive wheel.

27. A scooter as set forth in claim 26 wherein the scooter has a right turn pivot axis that extends generally between the front wheel and a pivot connection between the left pivot arm and the frame, the frame being tiltable about the right turn pivot axis in a right turn of the scooter, and a left turn pivot axis that extends generally between the front wheel and a pivot connection between the right pivot arm and the frame, the frame being tiltable about the left turn pivot axis in a left turn of the scooter.

28. A scooter as set forth in claim 21 wherein the scooter has a right turn pivot axis that extends generally between the front wheel and a pivot connection between the left pivot arm and the frame, the frame being tiltable about the right turn pivot axis in a right turn of the scooter, and a left turn pivot axis that extends generally between the front wheel and a pivot connection between the right pivot arm and the frame, the frame being tiltable about the left turn pivot axis in a left turn of the scooter.

29. A mid drive scooter for movement along the ground, comprising:
a frame that supports a seat for a rider of the scooter;
a front wheel connected with the frame;
left and right drive wheels;
left and right rear wheels; and
a left suspension interposed between the frame and the left wheels;
a right suspension interposed between the frame and the right wheels;
the left and right suspensions supporting the frame on the drive wheels for movement of the frame relative to the drive wheels in first and second degrees of freedom.

30. A scooter as set forth in claim 29 wherein each one of the left and right suspensions includes a pivot arm connected with the frame via a pivot connection, the pivot arm supporting the associated drive wheel forward of the pivot connection and supporting the associated rear wheel rearward of the pivot connection.

31. A mid drive scooter for movement along the ground, comprising:
a frame that supports a seat for a rider of the scooter;
a front wheel connected with the frame;
left and right drive wheels;
left and right rear wheels; and
means for supporting the frame on the drive wheels and the rear wheels for movement of the frame relative to the drive wheels in first and second degrees of freedom.

32. A scooter as set forth in claim 31 wherein the means for supporting comprises a left suspension interposed between the frame and the left wheels and a right suspension interposed between the frame and the right wheels.

33. A scooter as set forth in claim 31 wherein the means for supporting comprises:
a left pivot arm connected with the frame for pivotal movement relative to the frame about a first pivot axis, the left drive wheel being connected forward of the first pivot axis on a portion of the left pivot arm, and the left rear wheel being connected rearward of the first pivot axis on a portion of the left pivot arm, and
a right pivot arm connected with the frame for pivotal movement relative to the frame about the first pivot axis, the right drive wheel being connected forward of the first pivot axis on a portion of the right pivot arm, and the right rear wheel being connected rearward of the first pivot axis on a portion of the right pivot arm.

34. A scooter as set forth in claim 31 wherein the means for supporting comprises means for supporting the frame for movement relative to the drive wheels in first and second degrees of freedom.

35. A scooter as set forth in claim 34 wherein said means for supporting the frame for movement relative to the drive wheels in first and second degrees of freedom comprises left and right pivot arms.

36. A scooter as set forth in claim 35 wherein said means for supporting includes elastomeric bushings connecting the drive wheels and the pivot arms.

37. A scooter as set forth in claim 35 wherein the first degree of freedom is pivotal movement about a drive axis of the vehicle that extends between the left and right drive wheels and the second degree of freedom is tilting movement of the frame relative to the drive wheels.
